(19) United States
(12) Patent Application Publication
(10) Pub. No.: US 2014/0262274 A1
(43) Pub. Date: Sep. 18, 2014

(54) OXIDATIVE BREAKERS IN A SILICONE BASED SUSPENSION

(71) Applicant: CESI CHEMICAL, INC., Marlow, OK (US)

(72) Inventors: Keith Dismuke, Katy, TX (US); David Philpot, Marlow, OK (US); Randal Hill, The Woodlands, TX (US); Rondell Pennypacker, Duncan, OK (US); Steven Hill, Marlow, OK (US)

(21) Appl. No.: 13/830,925

(22) Filed: Mar. 14, 2013

(51) Int. Cl. C09K 8/524; E21B 43/25

(52) U.S. Cl. CPC C09K 8/524; E21B 43/25
USPC 166/300; 507/233

(57) ABSTRACT

An oxidative breaker system for use in reducing the viscosity of a guar-based suspension includes a silicone oil carrier fluid, an oxidizer and a suspension aid. The suspension aid is preferably fumed silica. The oxidizer may be selected from the group consisting of alkali metal peroxide, transition metal peroxide, persulfate, bromide and bromate. In highly preferred embodiments, the oxidizer is magnesium peroxide or calcium peroxide. Also disclosed is a method for breaking a guar-based suspension with the inventive oxidative breaker system.

### FIELD OF THE INVENTION

The present invention generally relates to the production of petroleum and more particularly to compositions and processes for improving the recovery of petroleum from a subterranean geological formation.

### BACKGROUND OF THE INVENTION

For many years, petroleum has been recovered from subterranean reservoirs through the use of drilled wells and production equipment. In many cases, it is desirable to utilize hydraulic fracturing techniques to improve primary and secondary recovery of oil and natural gas from the target reservoir. Hydrophilic polysaccharides and derivatized polysaccharides (such as guar gum, CMHPG, and HPG) are often used to form viscosified carrier gels during hydraulic fracturing operations. These viscosified gels suspensions are non-Newtonian and also can be cross-linked to give very high gel strength.

Following the well treatment operation, it is often desirable to retrieve the viscosified carrier fluids from the wellbore. To promote flowback from the well, these gel fluids can be broken to reduce the viscosity of the suspension. In many cases, “breakers” are introduced to facilitate and expedite the process of breaking the viscosified gels. The loss of viscosity is typically the result of an oxidative/reductive chemical mechanism.

The oxidative/reductive depolymerization of the polysaccharide is commonly used to reduce the viscosity of the gels. The oxidation of the polysaccharide is typically accomplished through a radical pathway in the presence of oxygen. Current oxidative type breakers frequently employ peroxide slurried in a carrier fluid. The prior art carrier fluids may include hydrocarbons, water, polymers and/or clay-based materials.

These breaker carrier fluids suffer from several known deficiencies. First, many of these breaker materials are combustible and flammable. The volatility of these carrier materials in the presence of an oxidizer necessitates special handling procedures. Second, these prior art carrier materials do not exhibit long-term stability in solution. The limited shelf life of these carrier fluids mandates that the breaker fluid be used promptly after the carrier fluid and oxidizer are mixed.

There is, therefore, a need for an improved oxidative breaker that overcomes these and other deficiencies in the prior art.

### SUMMARY OF THE INVENTION

Presently preferred embodiments of the invention include an oxidative breaker system for use in reducing the viscosity of a polysaccharide-based suspension. The oxidative breaker system includes a silicone oil carrier fluid, an oxidizer and a suspension aid. The suspension aid is preferably fumed silica. The oxidizer may be selected from the group consisting of alkali metal peroxide, transition metal peroxide, persulfate, bromide and bromate. In highly preferred embodiments, the oxidizer is magnesium peroxide or calcium peroxide.

In another aspect, preferred embodiments of the present invention include a method for reducing the viscosity of a guar-based high viscosity fluid in a downhole environment. The method includes the step of providing an oxidative breaker system, wherein the step of providing an oxidative breaker system comprises the step of mixing an oxidizer with a suspension aid in a silicone oil carrier fluid. The method continues by placing the oxidative breaker system in contact with the guar-based fluid. The method also includes the step of oxidizing the guar-based fluid with the oxidative breaker system to reduce the viscosity of the guar-based fluid.

### BRIEF DESCRIPTION OF THE DRAWINGS

FIG. 1 provides a graph showing the results of a laboratory test of the first preferred embodiment of the oxidative breaker system.

FIG. 2 provides a graph showing the results of a laboratory test of the second preferred embodiment of the oxidative breaker system.

### DETAILED DESCRIPTION OF PREFERRED EMBODIMENTS

The present invention generally provides an improved oxidative breaker system for use in reducing the viscosity of polysaccharide polymer-based fluids in a downhole environment. The inventive oxidative breaker systems include a carrier fluid, a suspension aid and an oxidizer. The oxidative breaker systems can be pumped downhole to reduce the viscosity of polysaccharide polymer-based fluids used in any well treatment operation, including, but not limited to, drilling, acidizing, hydraulic fracturing, cementing and water removal operations.

The water soluble polysaccharide polymers may be any of such polymers well known in the art. See for example the book “Handbook of Water-Soluble Gums and Resins,” Robert L. Davidson, Editor, McGraw-Hill Book Co., 1980, incorporated herein by reference. Representative polymers include water soluble salts of alginic acid, carrageenan, gum agar, gum arabic, gum ghatti, gum karaya, gum tragacanth, locust bean gum, tamarind gum, cellulose derivatives such as hydroxyethyl cellulose, hydroxypropyl cellulose, carboxymethyl cellulose, hydroxyethyl carboxymethyl cellulose, and the alkyl cellulose ethers, starch ether derivatives such as carboxymethyl starch, hydroxyethyl starch, hydroxypropyl starch, and crosslinked starch ethers, guar gum and its derivatives, such as hydroxypropyl guar, hydroxyethyl guar and carboxymethyl guar, biopolymers such as xanthan gum, gellan gum, welan gum, and the like. The polysaccharide polymer is typically a cellulose ether, a starch ether which may be crosslinked, a modified guar gum, xanthan gum, gellan gum, welan gum, or mixtures thereof.

In presently preferred embodiments, the carrier fluid is preferably silicone oil. Suitable silicone oils include liquid polymerized siloxanes with organic side chains, which include polydimethylsiloxanes. Suitable silicone oils have a base viscosity of between about 50 and 1000 mm²/s. Particularly preferred silicone oils include medium viscosity polydimethylsiloxanes having a base kinematic viscosity of about 350 mm²/s. The use of silicone oil as a carrier fluid for an oxidative breaker system has not been recognized in the prior art. Silicone oil has not been used in the past because of its perceived inadequacies in acting as a suspension material. The relatively high cost of silicone oil further discourages its use in this context.

Presently preferred suspension aids include fumed silica. Preferred oxidizers are solid and include alkali or transition metal peroxides, persulfates, bromides, hyperchlorites and bromates. Particularly preferred oxidizers include magnesium oxide and calcium peroxide. The oxidizer and suspension aids are preferably mixed together under mechanical agitation with the silicone oil carrier fluid to prepare the oxidative breaker system.

In a first preferred embodiment, the preferred oxidative breaker system includes between about 50% and 70% by weight silicone oil, between about 30% and 45% by weight magnesium oxide, and between about 0% and 2% by weight fumed silica. The oxidative breaker system is preferably presented in a ratio of about 3.5 to about 5.5 pounds of magnesium oxide per gallon of the oxidative breaker system.

In a highly preferred embodiment, the oxidative breaker system includes about 54% by weight silicone oil, about 45% by weight magnesium peroxide and about 1% by weight fumed silica. This highly preferred embodiment is presented at a ratio of about 5 pounds of active magnesium oxide to a gallon of the oxidative breaker system.

The oxidative breaker system optionally includes a dispersing agent. The dispersing agent can be used to accelerate the release of the oxidizer from the oxidative breaker system. Suitable dispersing agents include polydimethylsiloxane-polyalkylene oxide copolymers and polydimethyl-polyphenylmethyl-siloxane copolymers.

In a laboratory test, the first preferred embodiment of the oxidative breaker system successfully reduced the viscosity of a standard guar suspension. The oxidative breaker system was applied to a guar suspension prepared at a ratio of about 40 pounds of guar (GA-40W) to 1000 gallons of buffered tap water. The oxidative breaker system was prepared using about one pound of active magnesium peroxide to one gallon of the oxidative breaker system. The results of this test are presented in FIG. 1.

The test reveals that an increasing concentration of the oxidative breaker system accelerates the reduction in the viscosity of the guar suspension.

In a second preferred embodiment, the preferred oxidative breaker system includes between about 55% and 70% by weight silicone oil, between about 25% and 45% by weight calcium oxide, and between about 0% and 2% by weight fumed silica. The oxidative breaker system is preferably presented in a ratio of about 3.0 to about 5.0 pounds of calcium oxide per gallon of the oxidative breaker system.

In a highly preferred embodiment, the second preferred embodiment of the oxidative breaker system includes about 64% by weight silicone oil, about 35.6% by weight calcium peroxide and about 0.4% by weight fumed silica. This highly preferred embodiment is presented at a ratio of about 3.73 pounds of active calcium oxide to a gallon of the oxidative breaker system.

In a laboratory test, the second preferred embodiment of the oxidative breaker system successfully reduced the viscosity of a standard guar suspension. The oxidative breaker system was applied to a guar suspension prepared at a ratio of about 30 pounds of guar (GA-40W) to 1000 gallons of buffered tap water. The oxidative breaker system was prepared using about one pound of active calcium peroxide to one gallon of the oxidative breaker system. The results of this test are presented in FIG. 2.

The test reveals that an increasing concentration of the oxidative breaker system accelerates the reduction in the viscosity of the guar suspension.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed, as defined in the written description and appended claims. For example, surfactant and surfactant mixture selections can be modified and changed to take into account varying reservoir conditions.

It is claimed:

1. An oxidative breaker system for use in reducing the viscosity of a polysaccharide-based suspension, the oxidative breaker system comprising:
a carrier fluid, wherein the carrier fluid is a silicone oil; and
an oxidizer mixed within the carrier fluid.

2. The oxidative breaker system of claim 1, wherein the silicone oil is a polymerized siloxane with organic side chains.

3. The oxidative breaker system of claim 2, wherein the silicone oil is a polydimethylsiloxanes.

4. The oxidative breaker system of claim 3, wherein the silicone oil is a medium viscosity polydimethylsiloxanes having a base viscosity of between about 50 mm²/s to about 1000 mm²/s.

5. The oxidative breaker system of claim 4, wherein the silicone oil is a medium viscosity polydimethylsiloxanes having a base viscosity of between about 350 mm²/s.

6. The oxidative breaker system of claim 1, further comprising a suspension aid, wherein the suspension aid comprises fumed silica.

7. The oxidative breaker system of claim 1, wherein the oxidizer is selected from the group consisting of alkali metal peroxide, transition metal peroxide, persulfate, bromide and bromate.

8. The oxidative breaker system of claim 7, wherein the oxidizer is magnesium peroxide.

9. The oxidative breaker system of claim 8, further comprising:
about 50% to about 70% by weight silicone oil;
about 30% to about 45% by weight magnesium peroxide; and
about 0% to about 2% by weight fumed silica.

10. The oxidative breaker system of claim 9, further comprising:
about 54% by weight silicone oil;
about 45% by weight magnesium peroxide; and
about 1% by weight fumed silica.

11. The oxidative breaker system of claim 7, wherein the oxidizer is calcium peroxide.

12. The oxidative breaker system of claim 11, further comprising:
about 55% to about 70% by weight silicone oil;
about 25% to about 45% by weight calcium peroxide; and
about 0% to about 2% by weight fumed silica.

13. The oxidative breaker system of claim 12, further comprising:
about 64% by weight silicone oil;
about 36% by weight calcium peroxide; and
about 0.4% by weight fumed silica.

14. A method for reducing the viscosity of a polysaccharide-based fluid in a downhole environment, the method comprising the steps:
providing an oxidative breaker system, wherein the step of providing an oxidative breaker system comprises the step of mixing an oxidizer with a suspension aid in a silicone oil carrier fluid;
placing the oxidative breaker system in contact with the polysaccharide-based fluid; and
oxidizing the polysaccharide-based fluid with the oxidative breaker system to reduce the viscosity of the polysaccharide-based fluid.

15. The method of claim 14, wherein the step of providing an oxidative breaker system comprises the step of mixing an oxidizer with a suspension aid in a polydimethylsiloxane carrier fluid.

16. The method of claim 14, wherein the step of providing an oxidative breaker system comprises the step of mixing an oxidizer with fumed silica in a silicone oil carrier fluid.

17. The method of claim 14, wherein the step of providing an oxidative breaker system comprises the step of mixing magnesium peroxide with a suspension aid in a silicone oil carrier fluid.

18. The method of claim 14, wherein the step of providing an oxidative breaker system comprises the step of mixing calcium peroxide with a suspension aid in a silicone oil carrier fluid.

19. The method of claim 14, wherein the step of placing the oxidative breaker system in contact with the polysaccharide-based fluid comprises placing between about 2 and 4 gallons of the oxidative breaker system to every thousand gallons of polysaccharide-based fluid.
